(19) United States
(12) Patent Application Publication
(10) Pub. No.: US 2025/0178026 A1
(43) Pub. Date: Jun. 5, 2025

(54) Method for Obtaining a Coating of Two-Dimensional Material

(71) Applicant: GRAPHENE-XT SRL, Bologna (IT)

(72) Inventors: Cristian Trevisanut, Matelica (IT); Claudio Cacciola, Bologna (IT); Miquel Garcio Lleo, Bologna (IT); Simone Ligi, Zola Predosa (IT)

(21) Appl. No.: 18/862,028

(22) PCT Filed: May 3, 2023
(86) PCT No.: PCT/EP2023/061696

§ 371 Date: Oct. 31, 2024

(30) Foreign Application Priority Data
May 4, 2022 (IT) 102022000009011

(51) Int. Cl. B05D 3/12; B05D 1/38; B05D 3/10

(52) U.S. Cl. CPC B05D 3/12; B05D 1/38; B05D 3/107

(57) ABSTRACT

A method for obtaining a coating of two-dimensional material on a surface includes the steps of: a) forming a dispersion by mixing a laminar material and at least one exfoliating agent in a first solvent; b) subjecting the dispersion formed in step a) to at least one treatment chosen from sonication, mechanical milling, and micronization, and obtaining a dispersion including a two-dimensional material; b1) optionally, subjecting the dispersion including the two-dimensional material obtained in step b) to one or more of (1) extraction with solvents, (2) centrifugation, (3) filtration, and (4) concentration; c) applying the dispersion obtained in step b) or b1) on a surface and obtaining a wet surface; d) drying the wet surface obtained in step c); and e) optionally, repeating steps c) and d). The dispersion does not include binding agents or adhesion promoters.

The present invention relates to a method for obtaining a coating of two-dimensional material on a surface.

Coatings of two-dimensional materials are known, such as for example graphene which is the fundamental unit of graphite, which is formed by stacking multiple layers of graphene held together by van der Waals interactions.

Graphene and other two-dimensional materials can be produced with various different technologies which can be divided into three main groups:
i) mechanical exfoliation;
ii) chemical exfoliation; and
iii) atomic growth.

Within these groups there are numerous variants.
i) Mechanical exfoliation using Scotch tape, a technique used by the Nobel prize laureates Novoselov and Gejm, still remains the best technology for obtaining graphene in pure and non-oxidized form, also called “pristine” graphene. Unfortunately, with this technique it is possible to produce only a few sheets of graphene on silicon or silicon oxide, which in general have dimensions smaller than 2000 square microns; this, owing to the ensuing costs, limits the sector of application to scientific research only.

Mechanical milling, often using ball mills, of various raw materials such as graphite, pretreated bituminous pitch and carbonaceous products of various kinds, is used to obtain products at relatively low cost, up to a few hundred dollars per kilogram, but it is rare for these products to be constituted significantly by a single layer; more often, they are materials with distributions of up to 10 layers, and the lateral dimensions for the thinnest products do not exceed one micron.
ii) Chemical exfoliation takes advantage of the structure of graphite, which naturally is made up of layers of graphene bonded to each other by forces that are weaker than the forces along the plane; this difference in bonding forces makes it possible, via the use of various chemical compounds, to separate one or more planes from each other while keeping the planar structure of the graphene intact. Chemical exfoliation can be divided into two further groups:
ii.a) Exfoliation that keeps the properties of the graphene relatively unaltered;
or
ii.b) Exfoliation that modifies these properties to a substantial extent. In this latter case we speak of “chemically modified graphene” (CMG).
ii.a) Among the methods that keep the properties of the graphene relatively unaltered is exfoliation using solvents, such as for example n-methyl pyrrolidone (NMP) and dimethylformamide (DMF), which with the aid of the sonication process make it possible to obtain lateral dimensions in the order of microns for significant percentages of monolayer material. The disadvantage is that this type of solvent is difficult to remove from the surface of the graphene.

Another technique is exfoliation via the intercalation of chemical compounds and subsequent thermal expansion of the intercalated graphite. The final mechanical treatment generates graphene powder. This technique therefore combines the advantages of chemical exfoliation and mechanical action. In this case greater lateral dimensions are obtained than with mechanical exfoliation, but the technology is more complex and it is not clear whether the properties of the graphene remain unaltered.
ii.b) Among the techniques for producing CMG is a method that results in considerable lateral dimensions, up to 300 microns, with a near-totality of material in the monolayer structure: this is Hummers' method of exfoliation, known to the person skilled in the art, and some of its variations. Unfortunately the result of this process is not graphene, but its oxidized form, graphene oxide (GO); this material, although retaining good mechanical properties, completely loses its electrical properties and becomes completely insulating.

The inventors of the present invention have in the past devised a method for the production of a nanostructured material based on carbon (WO2014033274A1) that is a graphene formed from fewer than 10 mono-atomic layers, with a length-to-thickness ratio that exceeds 10 or even exceeds 100, and with an electrical conductivity that can exceed 5000 S/m.

The deposition of thin coatings is an industrial field in intense growth, owing to several advantageous practical aspects: it reduces the costs of the materials, it reduces the dimensions of the manufactured articles, it brings new characteristics that would not be possible with massive materials, and it speeds up production processes.

At an industrial scale, the processes most commonly used for the formation of thin layers are divided into:
chemical methods:
electroplating;
chemical baths;
chemical vapor deposition (CVD) and plasma enhanced chemical vapor deposition (PECVD);
atomic layer deposition (ADL), molecular layer deposition (MDL), and
physical methods:
physical vapor deposition (PVD) and the cathodic arc variation (arc-PVD);
molecular beam epitaxy (MBE);
sputter deposition; and
electrospray deposition.

Most of these techniques use conditions that are industrially expensive, such as high temperature, systems that operate under a vacuum, high energy consumption, or processes that are discontinuous and slow.

There are also simple coating techniques such as spray application, application by means of a stainless steel spiral applicator (Mayer bar), immersion coating, coating by means of rotary technologies (rotogravure, reverse roll, flexography, and variations thereof), slot-die coating, and curtain coating, which however currently require the use of binding agents and adhesion promoters.

The binding agents commonly used are oligomeric or polymeric products, polyurethanes, polyesters, acetates, silanes, oils, and acrylic, alkyd, or epoxy resins.

Binding agents, if used for depositing the two-dimensional materials, normally damage the properties of those materials, not only because they have completely different chemical/physical characteristics, but also because they increase the distance between adjacent sheets, thus increasing as a consequence the contact resistance.

In particular, the presence of binding agents in the graphene has a negative influence on several characteristics of the coating in that:
it reduces the electrical conductivity;
it reduces the thermal conductivity;
it contributes to the thickness of the coating, making it difficult if not impossible to obtain coatings of thickness less than 20 nm.

In light of the drawbacks described above, the aim of the present invention is to provide a simple method for producing a coating of two-dimensional material with characteristics that are advantageous, in particular in terms of electrical conductivity, thermal conductivity, and tribological properties.

Within this aim, an object of the invention is to provide an economically advantageous method that makes it possible to obtain a thin coating of two-dimensional material.

Another object of the invention is to provide coatings of two-dimensional material with characteristics that enable the use thereof, for example, for the production of conducting inks, conducting films, antistatic films, additives for plastic materials, sensors, transistors, diodes, optical modulators, transparent conducting materials, solar cells, batteries, ultracapacitors, a medium for medical or biomedical active ingredients, antibacterial substances, protective coatings, lubricating coatings, lubricants, paints, flexible electronics, metallic and polymeric composites or fillers for composites.

This aim and these and other objects which will become better apparent hereinafter are achieved by a method for obtaining a coating of two-dimensional material on a surface, which comprises the steps of:
a) forming a dispersion by mixing a laminar material and at least one exfoliating agent in a first solvent;
b) subjecting the dispersion formed in step a) to at least one treatment chosen from sonication, mechanical milling, and micronization, obtaining a dispersion comprising two-dimensional material; 15
b1) optionally, subjecting the dispersion comprising two-dimensional material obtained in step b) to one or more of:
extraction with solvents;
centrifugation;
filtration;
concentration;
c) applying the dispersion obtained in step b) or b1) on a surface, with a method chosen from the group constituted by spray application, application by means of a stainless steel spiral applicator (Mayer bar), immersion coating, coating by means of rotary technologies, slot-die coating, and curtain coating, obtaining a wet surface;
d) drying the wet surface obtained in step c), obtaining a coating of two-dimensional material on said surface;
e) optionally, repeating steps c) and d);
wherein said dispersion does not comprise binding agents or adhesion promoters.

The aims and the objects of the present invention are also achieved by a coating of a two-dimensional material obtainable according to the method of the invention.

The aim and the objects of the present invention are finally achieved by the use of the coating according to the invention for the production of conducting inks, conducting films, antistatic films, additives for plastic materials, sensors, transistors, diodes, optical modulators, transparent conducting materials, solar cells, batteries, ultracapacitors, a medium for medical or biomedical active ingredients, antibacterial substances, protective coatings, lubricating coatings, lubricants, paints, flexible electronics, metallic and polymeric composites or fillers for composites.

Further characteristics and advantages of the invention will become better apparent from the detailed description that follows.

In a first aspect, the present invention relates to a method for obtaining a coating of a two-dimensional material on a surface, which comprises the steps of:
a) forming a dispersion by mixing a laminar material and at least one exfoliating agent in a first solvent;
b) subjecting the dispersion formed in step a) to at least one treatment chosen from sonication, mechanical milling, and micronization, obtaining a dispersion comprising two-dimensional material;
b1) optionally, subjecting the dispersion comprising two-dimensional material obtained in step b) to one or more of:
extraction with solvents;
centrifugation;
filtration;
sedimentation;
c) applying the dispersion obtained in step b) or b1) on a surface, with a method chosen from the group constituted by spray application, application by means of a stainless steel spiral applicator (Mayer bar), immersion coating, coating by means of rotary technologies, slot-die coating, and curtain coating, obtaining a wet surface;
d) drying the wet surface obtained in step c), obtaining a coating of two-dimensional material on the surface;
e) optionally, repeating steps c) and d);
wherein the dispersion does not comprise binding agents or adhesion promoters.

Preferably, the mixing in step a) is carried out at a temperature comprised between −10° C. and 160° C., within the limits of the solvent used.

The methods used in step b) are known to the person skilled in the art. In the present invention, by “micronization” what is meant is a milling technique in which the dimensions of the fragments obtained are micrometrical and sub-micrometrical. Among the micronization techniques there is, for example, the use of high pressure fluid jets in a “jet mill”.

Non-limiting examples of material that can be used to obtain a two-dimensional coating with the method of the invention described above are examples 1-12 of WO2014033274A1.

Some applications require a high purity and dimensional homogeneity of the coating material. In these cases, the dispersion obtained in step b) is further treated (step b1) with one or more further techniques chosen from extraction with solvents, centrifugation, filtration, and concentration.

The application of the dispersion obtained in step b) or b1) can occur with the techniques listed above, which are known to the person skilled in the art. Rotary application techniques comprise rotogravure, reverse roll, flexography, and variations thereof.

The coating obtained with the method described above can be further stabilized via one or more washes with solvents.

In a preferred way of carrying out the method of the invention, the method further comprises the step f) of washing the coating of two-dimensional material obtained in step d) or e) with a second solvent selected from the group constituted by alcohols, aldehydes, ketones, esters, aliphatic hydrocarbons, aromatic hydrocarbons, chlorinated hydrocarbons, and mixtures thereof.

One or more further additives selected from the group constituted by dispersants, wetting agents, biocides, binding agents, carbon nanotubes (CNT), fullerenes, metals, graphene derivatives, antioxidants, polymers, dyes, and rheological additives, can be added to the dispersion prior to step c).

Preferably, the starting laminar material is selected from the group constituted by graphene, boron nitride, molybdenum disulfide, transition metal dichalcogenides, graphite and graphitic materials, phosphorene, and xenons.

In a preferred way of carrying out the method of the invention, the at least one exfoliating agent is selected from the group constituted by oligomers or polymers comprising from 1 to 1000 repetitive units, preferably from 3 to 20 repetitive units, comprising at least one ether group and at least one aryl group substituted with one or more functional groups selected from the group constituted by aromatic amines, aromatic amides, aromatic imines, aromatic sulfites, aromatic compounds of phosphorus, aromatic carboxylic acids, phenols, aromatic alcohols, aromatic ethers, aromatic aldehydes, aromatic esters, aromatic anhydrides, nitroaromatic groups, pyridine, pyrimidine, imidazole, azobenzene, anthracenes, diphenyls, aromatic halides, alkanes, and alkenes.

In another preferred way of carrying out the method of the invention, the at least one exfoliating agent is selected from the group constituted by one or more of polyvinyl alcohol (PVA), polyethylene oxide (PEO), polyoxyethylene (POE), polyethylene glycol (PEG), polypropylene glycol, carrageenan, and polyvinyl amine (PVAm).

In a preferred way of carrying out the method according to the invention, the at least one exfoliating agent is selected from the group constituted by one or more aryl ethoxylates, preferably comprising one or more of nonyl phenyl ethoxylate, and octyl phenyl ethoxylate in solution.

Preferably, the at least one exfoliating agent is in a quantity comprised between 0.01% and 80%, more preferably from 0.03% to 40%, even more preferably from 0.1% to 20% by weight on the total weight of the dispersion.

Preferably, the laminar material in the dispersion of step a) is in a quantity comprised between 0.5% and 80% by weight on the total weight of the dispersion.

Preferably the first solvent used to form the dispersion in step a) is selected from the group constituted by water, alcohols, esters, aldehydes and ketones.

The properties of the coating obtained with the method of the invention, such as for example electrical conductivity, thermal conductivity, optical properties, lubricating properties, absorption of radiation, surface tension, adhesion, effects on electromagnetic radiation, effects of electrical or photo-electrical interaction with other layers of materials, can be further improved via further steps of cleaning and activation of the surface. In particular, the removal of any residues that the previous treatments may leave on the surface of the two-dimensional material is advantageous.

In a preferred way of carrying out the method of the invention, the method further comprises the step g) subjecting the surface coated with two-dimensional material obtained in step d), e), or f) to one or more of ultraviolet (UV) radiation, infrared (IR) radiation, plasma, radiation, mechanical treatments selected from the group constituted by surface cleaning, brushing, lapping, and polishing.

In a second aspect, the present invention relates to a coating of a two-dimensional material obtainable according to any of the above ways of carrying out the method of the invention.

The method of the invention advantageously makes it possible to obtain thin layers with processes that are simple, continuous, having a low technology, without needing to use high temperatures or processes that operate under a vacuum.

Furthermore, the method of the invention advantageously does not entail the use of binding agents or adhesion promoters which are commonly used for producing coatings, with consequent advantages such as the possibility to produce thin layers while preserving the characteristics of the two-dimensional material such as electrical conductivity, thermal conductivity, lubricating properties, and optical properties.

If the dispersion is applied with low concentration of the laminar material, for example 0.01% by weight on the total weight of the dispersion, and then the solvent evaporates, a thin coating of up to 1.0 nm is generated. It is possible to vary the concentration or the number of thin layers deposited, in order to obtain coatings of 1.0-2000 nm, preferably 10-500 nm (expressed as the thickness of the dry material).

In a preferred embodiment, the coating has a thickness less than or equal to 20 nm.

The method of the invention makes it possible to obtain coatings characterized by:
electrical conductivity comprised between 0.01 Ohm/sq up to insulating levels, measured according to the ASTM F1711-96 (2016), IEC61340 Apr. 1 and IEC61340-4-5 standards;
thermal conductivity comprised between 0.1 W/mK up to 2000 W/mK, measured using transient thermoreflectance according to the ISO/TTA4:2002 standard;
friction coefficient of at least 0.01μ, measured according to the ASTM G99-17 standard;
adhesion to the substrate, measured with the cross cut test up to 5B according to the ASTM D3359 method;
hardness up to 6H, measured according to the ASTM D3363-20 standard.

The method of the invention makes it possible therefore to preserve the initial properties of the exfoliated material, i.e., for example in the case of graphene, electrical conductivity, thermal conductivity, and tribological properties, and in the case of boron nitride, thermal conductivity, radiation-screening properties and tribological properties.

In a third aspect, the present invention relates to the use of the coating obtainable using the method of the invention for the production of conducting inks, conducting films, antistatic films, additives for plastic materials, sensors, transistors, diodes, optical modulators, transparent conducting materials, solar cells, batteries, ultracapacitors, a medium for medical or biomedical active ingredients, antibacterial substances, protective coatings, lubricating coatings, lubricants, paints, flexible electronics, metallic and polymeric composites or fillers for composites.

The invention will now be described with reference to the following non-limiting examples.

### Example 1: Production and Characterization of a Coating of Graphene According to the Invention

50 g of graphite in powder form with particles of dimensions of up to 120 microns were mixed at 40° C. with 200 ml of a 0.1% solution of nonyl phenyl ethoxylate (Sigma-Aldrich) for 30 seconds, obtaining a dispersion. The dispersion was then milled with a ball mill using balls of diameter 0.3-1.2 mm, for 1 hour at the temperature of 40° C. The mixture thus obtained was then centrifuged for 4 minutes at 5400 rpm to remove the non-milled graphite. The dispersion was heated to 90° C. to concentrate the exfoliated graphene. After cooling, the upper part (of lower concentration) was removed and the concentrated solution was characterized using gravimetric analysis which gave a concentration of solids of 25 mg/ml. The dispersion thus obtained was sprayed with a nozzle spray on a polyester film until the film was completely covered. The film with the solution of graphene was then dried with an IR lamp and subsequently washed with acetone and air-dried.

The film coated with graphene was characterized in terms of electrical conductivity using a Warmbier SRM200 surface resistance meter, and using a 4-point analysis system according to the ASTM F1711-96 (2016) standard. The conductivity was found to be 20 Mohm/sq. IEC 61340-4-1, IEC 61340-4-5.

Then the film was cleaned by rubbing the surface with paper and the measurement of the surface resistance was repeated, and went from 20 Mohm/sq to 700 ohm/sq. Adhesion to the substrate was measured with the cross cut test which found a value of 5B according to the ASTM D3359 standard method.

### Example 2: Production and Characterization of a Coating of Boron Nitride According to the Invention

0.1 grams of boron nitride was added to 8 ml of a solution of water and 3% polyvinyl alcohol (PVA) (Sigma-Aldrich) and mixed at 60° C. for 20 seconds. The dispersion was sonicated for 20 hours with a Fisher Scientific sonicator, FB15047 30W 37 KHz, at a temperature of 60° C. The dispersion was centrifuged for 30 minutes at 3800 rpm. The concentration measured with the gravimetric method was 1.5 mg/ml. 4 ml of dispersion was applied with a Mayer bar on a wafer of silicon (p). When the solution was dry, washing was carried out with a 1:1 mixture of isopropanol and ethylacetate. The silicon wafer was analyzed using the Modulated Photothermal Radiometry (MPTR) technique, 3ω method, transient thermoreflectance, ISO/TTA 4:2002, which found a thermal conductivity greater than 50 W/mK.

### Example 3: Production and Characterization of a Coating of Graphene and Molybdenum Disulfide According to the Invention

3 kg of graphite flakes together with 300 grams of molybdenum disulfide was milled with a ball mill loaded with balls ranging from 1.5 up to 0.3 mm and with 20 kg of a 5% mixture of: styrenated phenol ethoxylate (Chemical China Ltd.) and polyvinyl amine in a ratio of 10:1. After 24 hours of milling the mixture was filtered with a filter with a 5 micron mesh. The dispersion thus obtained was used to coat steel disks by immersion (100Cr6) (EN ISO 683-17). After drying, two more coatings by immersion in the dispersion and subsequent drying cycles were performed. The disk was then washed with perchloroethylene and then pin-on-disk tribological analysis was conducted using the ASTM G99-17 method, which found a friction coefficient of 0.06μ.

In practice it has been found that the method according to the invention fully achieves the set aim in that it makes it possible to obtain with a method that is simple and economic, from an energy viewpoint, coatings of two-dimensional material that preserve the characteristics of the exfoliated starting material, without the drawbacks associated with the use of binding agents. The method of the invention furthermore makes it possible to advantageously obtain thin layers, with thicknesses of less than 20 nm.

The method thus conceived is susceptible of numerous modifications and variations, all of which are within the scope of the appended claims. Moreover, all the details may be substituted by other, technically equivalent elements.

In practice, the materials employed, as well as the dimensions, may be any according to requirements and to the state of the art.

This patent application is based in part on the results of projects that received funding from the H2020 research and innovation program; Graphene Flagship grant agreement no. 881603; and from Graphene Flagship no. 649953; and from Marie Skłodowska-Curie grant agreement no. 956923-StiBNite.

The disclosures in Italian Patent Application No. 102022000009011 from which this application claims priority are incorporated herein by reference.

1-10. (canceled)

11. A method for obtaining a coating of a two-dimensional material on a surface, comprising the steps of:
a) forming a dispersion by mixing a laminar material and at least one exfoliating agent in a first solvent;
b) subjecting the dispersion formed in step a) to at least one treatment selected from the group consisting of sonication, mechanical milling, and micronization to obtain a dispersion comprising a two-dimensional material;
b1) optionally, subjecting the dispersion comprising two-dimensional material obtained in step b) to one or more of (1) extraction with solvents, (2) centrifugation, (3) filtration, and (4) concentration;
c) applying the dispersion obtained in step b) or b1) on a surface, with a method selected from the group consisting of (1) spray application, (2) application by means of a stainless steel spiral applicator (Mayer bar), (3) immersion coating, (4) coating by means of rotary technologies including rotogravure, reverse roll, flexography, or variations thereof, (5) slot-die coating, and (6) curtain coating, to obtain a wet surface;
d) drying the wet surface obtained in step c) to obtain a coating of the two-dimensional material on the surface; and
e) optionally, repeating steps c) and d), wherein the dispersion is without binding agents or adhesion promoters.

12. The method according to claim 11, further comprising the step of f) washing the coating of two-dimensional material obtained in step d) with a second solvent selected from the group consisting of alcohols, aldehydes, esters, ketones, aliphatic, aromatic and chlorinated hydrocarbons, and mixtures thereof.

13. The method according to claim 11, comprising adding to the dispersion prior to step c) one or more additives selected from the group consisting of dispersants, wetting agents, biocides, binding agents, carbon nanotubes (CNT), fullerenes, metals, graphene derivatives, antioxidants, polymers, dyes, and rheological additives.

14. The method according to claim 11, wherein the laminar material is selected from the group consisting of graphene, boron nitride, molybdenum disulfide, transition metal dichalcogenides, graphite or graphitic materials, phosphorene, and xenons.

15. The method according to claim 11, wherein the at least one exfoliating agent is selected from the group consisting of:
a) oligomers or polymers comprising from 1 to 1000 repetitive units comprising at least one ether group and at least one aryl group substituted with one or more functional groups selected from the group consisting of aromatic amines, aromatic amides, aromatic imines, aromatic sulfites, aromatic compounds of phosphorus, aromatic carboxylic acids, phenols, aromatic alcohols, aromatic ethers, aromatic aldehydes, aromatic esters, aromatic anhydrides, nitroaromatic groups, pyridine, pyrimidine, imidazole, azobenzene, anthracenes, diphenyls, aromatic halides, alkanes, and alkenes; or
b) one or more of polyvinyl alcohol (PVA), polyethylene oxide (PEO), polyoxyethylene (POE), polyethylene glycol (PEG), polypropylene glycol, carrageenan, and polyvinyl amine (PVAm).

16. The method according to claim 12, further comprising the step of g) subjecting the surface coated with two-dimensional material obtained in step d), e), or f) to one or more of ultraviolet (UV) radiation, infrared (IR) radiation, plasma, radiation, or mechanical treatments selected from the group consisting of surface cleaning, brushing, lapping, and polishing.

17. The method according to claim 11, wherein the first solvent is selected from the group consisting of water, alcohols, aldehydes, esters, and ketones.

18. The method according to claim 11, wherein the at least one exfoliating agent is selected from the group consisting of one or more aryl ethoxylates, and octyl phenyl ethoxylate in solution.

19. A coating of a two-dimensional material formed according to the method of claim 11.

20. Use of the coating of claim 19 for the production of one or more of conducting inks, conducting films, antistatic films, additives for plastic materials, sensors, transistors, diodes, optical modulators, transparent conducting materials, solar cells, batteries, ultracapacitors, a medium for medical or biomedical active ingredients, antibacterial substances, protective coatings, lubricating coatings, lubricants, paints, flexible electronics, metallic and polymeric composites, or fillers for composites.
